(19) United States
(12) Patent Application Publication
(10) Pub. No.: US 2022/0106455 A1
(43) Pub. Date: Apr. 7, 2022

(54) METHOD OF PREPARING A NANO- AND/OR MICROSCALE CELLULOSE FOAM

(71) Applicants: Weidmann Holding AG, Rapperswil (CH); EMPA Eidgenössische, Dübendorf (CH)

(72) Inventors: Stefan TRUNIGER, Pfaffikon ZH (CH); Carlo ANTONINI, Carate Brianza (MB) (IT); Thomas GEIGER, Dübendorf (CH); Otto NYLÉN, Helsinki (FI)

(73) Assignees: Weidmann Holding AG, Rapperswil (CH); EMPA Eidgenössische, Dübendorf (CH)

(21) Appl. No.: 17/299,586

(22) PCT Filed: Jun. 24, 2019
(86) PCT No.: PCT/EP2019/066704

§ 371 Date: Jun. 3, 2021

(30) Foreign Application Priority Data
Dec. 4, 2018 (EP) 18210076.8

(51) Int. Cl. C08J 9/28; C08J 9/36

(52) U.S. Cl. CPC C08J 9/28; C08J 9/36; C08J 2301/02; C08J 2205/042; C08J 2205/044; C08J 2201/0482

(57) ABSTRACT

The present invention relates to a method for the preparation of a nano- and/or microscale cellulose-based foam. The method comprises the steps of (i) providing a suspension (1) comprising nano- and/or microscale cellulose in an aqueous medium, (ii) simultaneously cooling and agitating the suspension (1) in a mechanical step (2a; 2b) to obtain an at least partially frozen suspension. (iii) freezing the at least partially frozen suspension (5) to obtain a substantially frozen suspension, (iv) treating the suspension under solvent-exchange (7; 8) and (v) removing the solvent (10; 13) to obtain a substantially dry foam (40A) comprising nano- and/or microscale cellulose.

### TECHNICAL FIELD

The application relates to a method for preparing a nano- and/or microscale cellulose-based foam, to a nano- and/or microscale cellulose-based foam obtained with the method and the use of a nano- and/or microscale cellulose-based foam.

### PRIOR ART

Cellulose is a naturally occurring polymer made of repeating units of cellulose. Microfibrillated cellulose (MFC) is cellulose, in which the outer layer of the cellulose fibers has been removed, exposing the fibril bundles. The fibril bundles consist of individual micro fibrils, also called elementary fibrils. The average lengths of the individual micro fibrils of microfibrillated cellulose can be up to several micro meters. The individual micro fibrils of nanofibrillated cellulose (NFC) usually have a fiber length below 500 nm. Due to the certain characteristics of fibrillated cellulose, such as low density, high strength and tunable surface chemistry, this renewable and biocompatible nanomaterial has been experienced an increasing interest in industry. Microcrystalline cellulose is a purified, partially depolymerized cellulose prepared by treating alpha-cellulose, obtained as a pulp from fibrous plant material, with mineral acids. The degree of polymerization is typically less than 400. The length of the individual crystals can be up to several micrometers.

One focus has been the consideration of using nanocellulosic material in the preparation of foams and aerogels. Methods of preparing foams out of a cellulose-containing suspension have been described in literature. A commonly used method comprises the step of rapid freezing of an aqueous cellulose fibril suspension, e.g. with liquid nitrogen, and subsequent thawing and drying under vacuum. This method provides a homogenous freezing of the suspension and leads to a homogeneous porous aerogel, but consumes a high amount of energy, which, in return, leads to significant production costs. Another example comprises the step of unidirectional ice templating where the orientation and growth of the ice crystals are controlled. US 2016/0369078 describes the preparation of foams with honeycomb structure using the technique of unidirectional ice templating and aims at using the foams as construction material. Unidirectional ice templating is achieved by nucleation induction, using either nucleation seeds or vessels with a base, that permits efficient heat transfer to execute directional cooling. The obtained pores have essentially an elongated open structure. Usually, freeze-drying is used to remove water and in order to obtain the cellulose-based foam, since freeze-drying may be essential in order to maintain a homogenous porous structure. Further, it has been described that a supercritical drying technique in liquid carbon dioxide under high pressure may avoid a low porosity as, for example, described in WO 2012/134378. However, methods including a supercritical drying technique do not provide economically reasonable applications.

Another approach without the need of freeze-drying has been described in WO 201 6/068 771 A1. Wet foams were produced by mechanical whisking to maintain the porous structure of a solid material made from nanofibrillated cellulose. A gas was dispersed in a liquid medium, wherein the bubbles of gas are separated from each other or from the liquid or solid medium by surfactants. Subsequently, the wet foams were dried in a fan oven. Thus, this method requires additional compounds for the production of the foams, which might alter the properties of the nanocellulosic material.

However, currently known methods are rather time and energy consuming and thus expensive, which does not favor their industrial application.

### SUMMARY OF THE INVENTION

It is thus an object of the present invention to overcome the drawbacks of the prior art. It is further an object of the present invention to provide a method for the preparation of nano- and/or microscale cellulose-based foams, which is economical, ecological, less time consuming and industrially feasible. It is also an object of the present invention to provide a nano- and/or microscale cellulose-based foam with enhanced properties, which can be produced in a cost-efficient manner. Further, it is also an object of the invention to provide a use of a nano- and/or microscale cellulose-based foam.

At least a part of these objects has been solved by the subject-matters as indicated in the independent claims. Further preferred embodiments are provided in the dependent claims.

A first aspect of the present invention is a method for the preparation of a porous nano- and/or microscale cellulose-based foam. The method comprises the steps of:
a) Providing a suspension comprising nano- and/or microscale cellulose in an aqueous medium;
b) Simultaneously cooling and agitating the suspension in a mechanical step to obtain an at least partially frozen suspension;
c) Freezing, preferably without agitating, the at least partially frozen suspension to obtain a substantially frozen suspension;
d) Treating the suspension under solvent-exchange;
e) Removing the solvent to obtain a substantially dry foam comprising nano- and/or microscale cellulose.

The method provides a foam with improved homogeneity of pores and a very high porosity without the need of additives such as surfactants. Structural stability of the foam skeleton upon drying is promoted by the solvent exchange step. The energy consumption is low compared to known methods making the preparation of the foams cost efficient and thus industrial applicable. The production capacity can be improved. Compared to unidirectional ice templating, the freezing time can be significantly reduced. The mechanical strength of the foam can be improved with regard to methods known in the art such as unidirectional ice templating.

A further advantage of the suspension is its easy processibility, usability with conventional apparatuses and avoidance of plugging of the machines and pumps. Further, it supports the stability of the foam during drying and promotes homogeneity and high porosity of the dry foam.

Even foams with ultra-high porosity of up to 99.4% could be produced. Foams with pores sizes in the order of 100 μm were observed.

The aqueous medium in step a) is preferably water. The water may be purified water obtained after distillation or deionization. Water from natural sources may also be used and may additionally contain ions. Purified water, in particular deionized water, is preferred. A mixture of water and water miscible solvents such as ethanol may also be suitable.

The cooling of the suspension in step b) may occur by applying cooling in an electrical manner as known to those skilled in the art. Alternatively, cooling may be obtained by adding directly ice such as ice cubes or crushed ice to the suspension such that an ice slurry comprising frozen aqueous medium and the nano- and/or microscale cellulose is obtained. In any case, cooling occurs simultaneously to a mechanical agitation step. The simultaneous cooling-agitation step may be a batch-type process. The cooling-agitation step may be performed in an ice slurry-generating machine such as an ice cream machine, sorbet machine, ice extruder or the like. Alternatively, the cooling-agitation step may be provided in a continuous unit such as an extruder, preferably a low-temperature extruder. The aqueous suspension of nano- and/or microscale cellulose may be conveyed and agitated by a conveyor element such as a screw and, at the same time, may be frozen.

Substantially frozen suspension in step c) means an almost completely frozen suspension where at least 95% of the aqueous medium is frozen. The frozen amount of aqueous medium can be determined by temperature control. Freezing can be carried out by conventional industrial freezers as known in the art.

Step d) may be performed by either using the substantially frozen suspension obtained in step c) or by optionally thawing the substantially frozen suspension before solvent exchange treatment. Step d) is preferably performed until a substantially solvent saturated foam is obtained. By “solvent-saturated” it is meant that the equilibrium between the solvent and the aqueous medium within the foam is reached. A substantially solvent saturated foam may be a foam where the aqueous medium is exchanged by the solvent by at least 70%, preferably 75 to 90% and most preferably more than 90%. Preferably, the foam obtained after step d) comprises no more than 30%, preferably 25% to 10% and most preferably less than 10 water. Thus, the foam obtained after step d) is preferably substantially water-free.

The method steps a)-e) are preferably carried out in consecutive order.

Preferably, the substantially dry foam obtained after step e) comprises no more than 5 wt % solvent and/or water. Drying can be carried out with a variety of commercially known industrial dryers, such as convection dryer, impingement dryer, oven-dryer or contact dryer.

Preferably, the nano- and/or microscale cellulose-based foam does not contain more than 1 wt % of hemicellulose or lignin and even more preferably is free of hemicellulose or lignin. The nano- and/or microscale cellulose may comprise nanofibrillated and/or microfibrillated and/or nanocrystalline and/or microcrystalline cellulose. The cellulose-based foam can comprise a mixture of all four cellulose types or only nano- and/or microcrystalline cellulose or nano- and/or microfibrillated cellulose. Nano- and/or microfibrillated cellulose is preferred. The average lengths of the individual micro fibrils of the microfibrillated cellulose is in the range of 500 nm-1000 μm, preferably between 500 nm and 600 μm and most preferably between 500 nm and 400 μm and even more preferably between 500 nm and 200 μm. The individual nano fibrils of nanofibrillated cellulose (NFC) have an average fiber length below 500 nm, preferably between 5 nm and 500 nm. The average width of the individual nano fibrils and micro fibrils are usually between 3 and 100 nm. The aspect ratio for nano- and/or microfibrillated cellulose is preferably greater than 10. The particles of nano- and/or microcrystalline cellulose have an average width of 3 to 50 nm. The particles of nanocrystalline cellulose have an average length from 100 nm to 1 μm. The particles of microcrystalline cellulose have a length above 1 μm, preferably between 1 μm and 5 μm. The aspect ratio is preferably between 5 and 50.

The assessment of the average length is preferably carried out by means of the standard ISO 13322-2, 1. Edition of Nov. 1, 2006 which is incorporated herein as reference.

Further, by “nano- and/or microscale cellulose-based” is meant that the main component of the foam is nano- and/or microscale cellulose. Thus, at least 50 wt %, preferably more than 80 wt %, even more preferably more than 90 wt % is nano- and/or microscale cellulose and most preferably the foam consists of at least 90 wt % nano- and/or microscale cellulose and maximally 10 wt % water.

Preferably, the suspension provided in step a) comprises 0.3 to 3 wt. %, preferably 0.5 to 3 wt. %, more preferably 0.9 to 2.5 wt. % and most preferably 1.2 to 1.7 wt. %, of nano- and/or microscale cellulose. Preferably, the suspension comprises nano- and/or microfibrillated cellulose, in particular a mixture of nano- and microfibrillated cellulose. An optimum concentration range for a high absorption capacity of liquid mediums such as low viscous alkanes was found in the range of 0.5 to 1.2 wt. %, while a concentration range of 1.5 to 2.5 wt. % was found to be optimum with regard to mechanical stability. Thus, the concentration range provides a reasonable balance between very good absorption capacity and mechanical stability of the foam, depending on the desired application. The foams are provided with pore sizes in the order of 100 μm, measured with SEM Fei Nova Nanosem 230 Instrument (Fei, USA), wall thickness increases with increasing concentration of nano- and/or microfibrillated cellulose. The properties can be tuned by the initial concentration of nano- and/or microscale cellulose.

The nano- and/or microscale cellulose may be manufactured from cellulosic raw material such as wood, pulp or bleached pulp by refining. The manufacturing method can include enzymatic pre-treatment, ball-milling, friction grinding or high-pressure homogenization or a combination of two or more of these processes. The manufacture may also comprise the treatment with mineral acid. Preferably, the initially used nano- and/or microscale cellulose is fibrillated cellulose and has a specific BET surface area of 100 to 300 m²/g, preferably 240 m²/g. Preferably and according to Tappi T271 pm-91, the amount of cellulose particles with a fiber length of less than 200 μm is 80% or higher with regard to the dry content of cellulosic material used in the suspension.

The micro- and/or nanofibrillated cellulose used according to this invention can be chemically or physically functionalized as known to those in the art.

The suspension provided in step a) can additionally comprise urea, preferably between 0.5 and 3 wt % urea, most preferably 2-3 wt % urea. Urea influences the ice crystal formation, promotes the homogeneity of the pore size distribution and, therefore, the stability of the foam and may be removed during the solvent exchange step such that the dry foam is substantially free of urea. By “substantially free” it is meant, that the amount of urea does not exceed 500 ppm (500 mg urea per 1 kg cellulosic foam)

The at least partially frozen suspension in step b) comprises 10 to 90 wt % of aqueous medium in solid, i.e. frozen state, preferably 20 to 80 wt % and most preferably 30 to 70 wt %. A suspension comprising 30 to 70 wt % of aqueous medium in solid state after step b) showed the highest absorption capacity. In case the aqueous medium is only water, the solid state is ice.

The percentage of frozen water or of the aqueous medium in solid state can be determined by monitoring the temperature of the suspension and the freezing time after the suspension has reached the freezing temperature. As an example, if 1 kg of water (1 kcal/kgK) cools from 20 to 0° C.; in 10 minutes with constant cooling power and knowing the water latent heat of fusion (80 kcal/kg), it will take 40 minutes at 0° C. for the suspension to freeze completely. These data can be used to calculate the amount of energy that is released during the freezing. The values obtained can be compared to the energy that would have been released.

Surprisingly, it was found that dry foams obtained by first partially freezing and agitating the cellulose suspension and substantially freezing the whole suspension in a second process step show an improved mechanical strength and provide a very good absorption capacity. Thus, the freezing of the at least partially frozen suspension in step c) is preferably carried out in a state in which the suspension is resting, i.e. is not agitated. Further, the energy efficiency is improved and a higher production throughput is enabled. Additionally, the partially frozen suspension is easy to pour into molds, if shaping of foam is desired.

The at least partially frozen suspension obtained in step b) can be poured into a mold, preferably a pre-cooled mold. The mold supports the maintenance of the structure. A defined and tailor-made geometry of foam can be obtained. Any geometry can be obtained, such as cubes, cuboids, hollow cylinders, circular cylinders, pyramids, cones, spheres and prisms with any number of edges, depending on the desired application. Further, the suspension may be frozen according to step c) by placing the mold into the freezer. The mold also facilitates the maintenance of the structure if the suspension is thawed before the solvent exchange step d). The mold may be a silicone mold.

Preferably, step d) is performed by immersing the suspension at least once in a solvent. The suspension can still be in the frozen state or thawed. The solvent exchange step may be carried out under heating such that the frozen suspension is thawed during solvent exchange or thawing may take place under ambient conditions (23° C., 50% RH, 1013 mbar). Alternatively, the suspension can be thawed before solvent exchange.

The suspension may be immersed more than once, preferably twice or three times and preferably in several solvent baths for a faster solvent exchange such that e.g. the equilibrium towards a solvent-saturated foam is achieved more rapidly. It is also possible to immerse the suspension in only one solvent bath with only one solvent or a mixture of solvents and to keep the suspension inside the bath until e.g. the equilibrium between the solvent or solvents and water within the foam is reached. If several solvent baths are used, it is also possible to use a different solvent for each individual solvent bath.

Preferably, the solvent or solvent mixture is drained after the solvent exchange in step d) and before the drying in step e).

The solvent exchange facilitates the drying of the foam in step e) since the removal of the solvent or solvent mixture is easier and faster than the removal of the aqueous medium, in particular water, because of its lower evaporation pressure. Thus, the solvent usually does not comprise any water or comprises only small amounts of water, such as less than 50%, preferably less than 30% of water. Surprisingly, it was found that the solvent exchange step also promotes the stability of the foam during drying, the homogeneity and the very high porosity of the foam. Collapsing of the foam is avoided. It further serves at removing the urea and speeding up the thawing process.

Preferably, the solvent is a water-miscible solvent with a boiling point below 100° C. at standard ambient conditions and high vapor pressure. The vapor pressure is preferably above the one of water of 24 mmHg at ambient conditions. For example, the solvent can be ethanol, propanol, iso-propanol or tert-butanol. Ethanol is especially preferred. Ethanol shows a vapor pressure around 59 mmHg at ambient conditions. The solvent can be a pure solvent. Denaturing agents and water up to 50% are tolerable and do not show an influence on the foam formation.

The advantage of such solvents can be found in their easy removal. Ethanol is in particular suitable due to its limited health and safety hazards. It can easily be recycled.

Preferably, the solvent is recycled and led back into the process. The recycle step can be carried out by conventional methods known in the art such as azeotropic or reactive rectification. The recycling step can be incorporated after the drainage of the solvent and/or after the drying step e). The recycling step may comprise the separation of ethanol from water.

The recycling of the solvent, in particular ethanol, makes the method economically and ecological friendlier.

The method may additionally comprise the step of hydrophobizing the foam comprising the nano- and/or microscale cellulose. The hydrophobizing may be carried out after step d) or e) and allows the tuning of the foam properties according to the desired application. Alternatively, the nano- and/or microscale cellulose, in particular the nano- and/or microfibrillated cellulose may be chemically or physically functionalized before step a).

Hydrophobizing the foam can be obtained by method known in the art and that are directed to the reaction of the free hydroxylgroups of the cellulose. Hydrophobizing can be obtained by reactions with anhydrides such as alkenyl succinic anhydride (ASA), isocyanates such as 3-isopropenyl-a, a-dimethyl benzyl isocyanate (m-TMI), alkyl ketene dimers (AKD), imiden, triazine or silane. It may also be possible to use gas phase reactions with silane derivatives via Chemical Vapor Deposition.

Preferably, step e) is performed at temperatures between room temperature and 190° C. preferably between 50 and 110° C. and most preferably between 60 and 80° C. Drying can be carried out in conventional dryers known in the art such as convection dryer, impingement dryer, contact dryer. The ignition point of the solvent may be considered by choosing the drying temperature. The ignition point may be negligible if the amount of removable solvent is insignificantly small.

A further aspect of the invention is a nano- and/or microscale cellulose based foam obtainable by a method as previously described.

Preferably, the nano- and/or microscale cellulose based foam has a density of 0.01-0.3 g/cm³. The density can be determined based on the volume of absorbed oil by the following equation:

ρ=m_{cell}/Vₜₒₜ.

M_{cell} is the sample mass, Vₜₒₜ is the total volume and calculated with Vₜₒₜ=V_{cell}+Vₒᵢₗ, where V_{cell}=m_{cell}/ρ_{cell}. V_{cell} is the volume of cellulose, m_{cell} is the mass of cellulose and ρ_{cell} is the density of cellulose.

Preferably, the nano- and/or microscale cellulose based foam has a specific BET surface area between 30 m²/g and 100 m²/g, preferably between 40 m²/g and 80 m²/g and most preferably between 50 m²/g and 60 m²/g.

A high BET surface area correlates to the porosity and thus to high absorption capacity.

Preferably, the nano- and/or microscale cellulose based foam has an oil absorption property of more than 40 Lₒᵢₗ/kg_{cell}, preferably more than 60 Lₒᵢₗ/kg_{cell}, and most preferably more than 70 Lₒᵢₗ/kg_{cell}.

Oil absorption capacity reaching up to 100 Lₒᵢₗ/kg_{cell} could be found for a concentration of nano- and/or microfibrillated cellulose in the range of 0.6 to 0.7 wt. % and a ratio of 1:1 of nano- and/or microfibrillated cellulose and urea, calculated at a ratio between the absorbed oil volume and the cellulose mass. Lₒᵢₗ defines the absorbed liter of oil, kg_{cell} defines the cellulose mass.

Such foams are especially suitable for the use as oil absorption device and can be used in water bodies, such as lakes, rivers and seas, as oil spill-combating equipment.

Oil in the context of the invention refers to all organic liquids that are non-miscible with water and show a higher viscosity as water, particularly to mineral oils, silicone oils or fatty oils. Non-limiting examples are fuel oil, diesel oil or cooking oil.

A further aspect of the invention is the use of a nano- and/or microscale cellulose based foam produced with a method as previously described for the sorption of fluids. Fluids may be liquids or gases such as oil, carbon dioxide (CO₂), organic liquid solvent wastes or body fluids such as blood, “Sorption” refers general to either adsorption or absorption, wherein adsorption is the process with regard to gases, while absorption is the process with regard to liquids. The use for oil absorption is particularly preferred, in particular as an oil spill-combating device.

A further aspect of the invention is the use of a nano- and/or microscale cellulose based foam as an electrical insulating material.

### SHORT DESCRIPTION OF THE FIGURES

The invention will be described in more details by the following exemplary embodiments in FIGS. 1 to 9, without the invention being restricted to these embodiments. In particular, individual steps are exchangeable between the exemplary embodiments and can be equally combined. Same reference signs in the figures indicate same or similar objects. It shows:

FIG. 1: A first embodiment of the process according to the invention.

FIG. 2: A second embodiment of the process according to the invention.

FIG. 3: A third embodiment of the process according to the invention.

FIG. 4: Comparison between a foam obtained by a method according to the invention and a foam obtained without solvent exchange.

FIG. 5: Comparison between foams obtained by rapid freezing with and without solvent exchange.

FIG. 6: Comparison between foams obtained by unidirectional ice templating with and without solvent exchange.

FIG. 7: Pictures from cut foams from the foams of FIGS. 4, 5 and 6.

FIG. 8: SEM imaging of the cut foams of FIG. 7.

FIG. 9: Optical microscope of the cut foams of FIG. 7.

FIG. 11: Influence of the concentration of nano- and/or microfibrillated cellulose on porosity and wall thickness.

### DESCRIPTION OF PREFERRED EMBODIMENTS

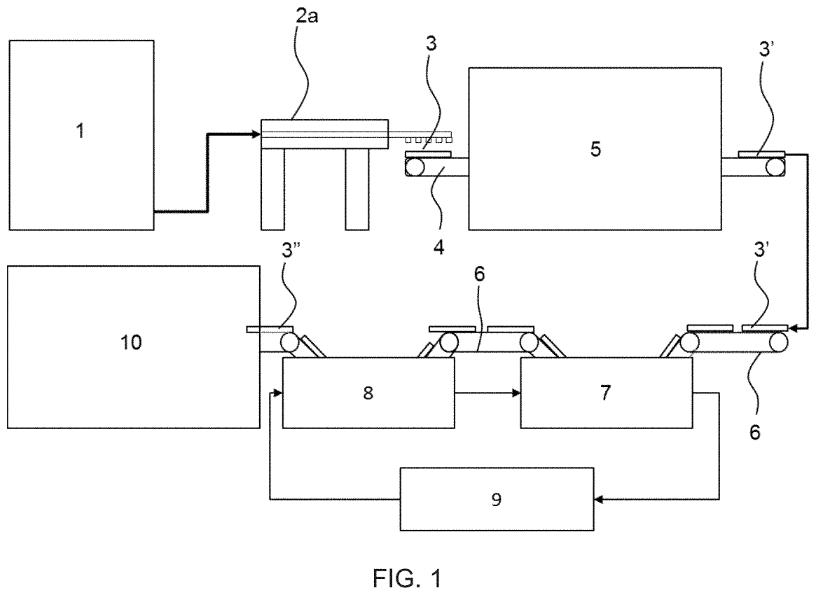

FIG. 1 shows a first exemplary embodiment for the process of the preparation of a nano- and/or microscale cellulose-based foam. A suspension 1 of nano- and/or microscale cellulose in water mixed with urea is applied to a low-temperature extruder 2a, in which the suspension is partially frozen, conveyed and agitated simultaneously and continuously. The partially frozen suspension is extruded into molds 3. The molds 3 are conveyed into a freezer 5 by means of a conveyor 4. The molds with the frozen suspension 3′ are transported to a first solvent bath 7 by further conveying means 6 to exchange the water for ethanol. In order to complete solvent exchange and enhance thawing the molds are placed into a second solvent bath 8. The ethanol containing wet foams 3″ obtained after the solvent exchange bath 7 and 8 are placed into a convection dryer 10 for drying the foam. The ethanol of the solvent bathes 7 and 8 is recycled by conventional recycling means 9 and led back to the solvent baths 7 and 8.

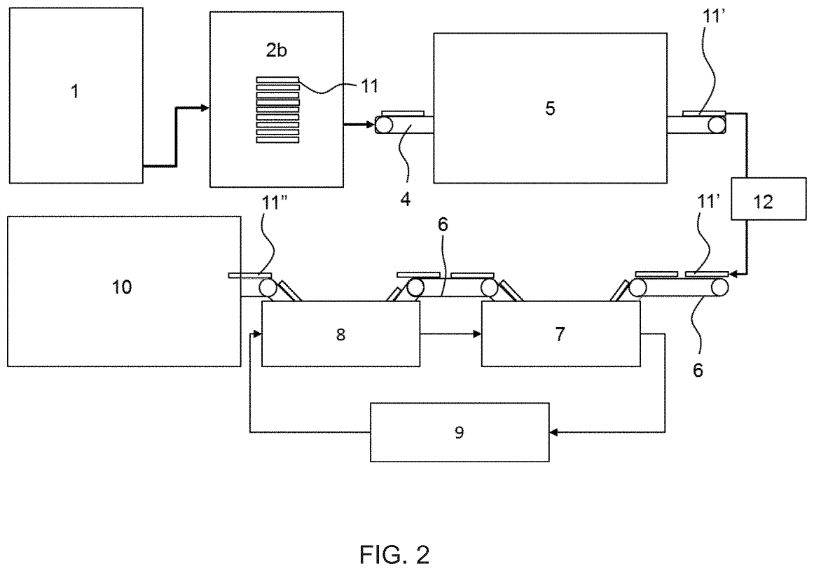

FIG. 2 shows a second embodiment of the process according to the invention. Compared to FIG. 1, the suspension 1 is partially frozen simultaneously to an agitation step in a batch process 2b providing different batches 11 with partially frozen suspension. The batches 11 are placed on a conveyor 4 and transported into a freezer 5 releasing batches with substantially completely frozen suspensions 11′. In FIG. 2, the frozen suspensions 11′ are thawed in a defrosting device 12 before placement into the solvent baths 7 and 8. The ethanol containing wet foams 11″ are dried in a dryer 10. The ethanol of the solvent bathes 7 and 8 is recycled as previously described.

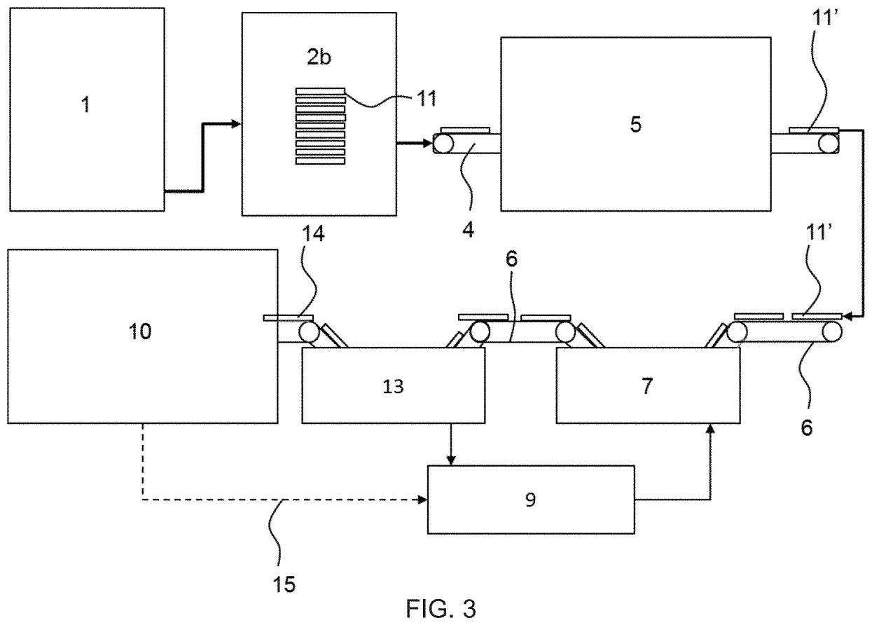

FIG. 3 shows a third embodiment of a process according to the invention. The first steps of the process are identical to the ones described in FIG. 2. However, in FIG. 3 the substantially frozen suspension 11′ is directly placed into a solvent bath 7 without an additional thawing step. The suspension is left in solvent bath 7 until the solvent exchange has reached equilibrium and the suspension is substantially thawed such that a wet foam is obtained. After the solvent bath, the wet foam is subjected to a drainage step 13. The solvent of the drainage step 13 is subjected to recycling means 9 and led back to solvent bath 7. The less wet foam 14 as compared to the examples given with regard to FIGS. 1 and 2 is conveyed to a convection dryer 10 to obtain a substantially dry foam. The solvent which was removed in the convection dryer 10 is fed to the recycling means 9 by conventional methods 15.

### EXAMPLES

Materials

The microfibrillated cellulose used in the following examples has a specific BET surface area of 240 m²/g. According to Tappi T271 pm-91 the amount of cellulose particles with a fiber length of less than 200 μm is 80% or higher with regard to the dry content of cellulosic material used in the suspension.

Water was used with the grades according to ISO 3696 (1987) and ASTM (D1193-91). The ethanol used was ethanol absolutus with 5% isopropanol purchased from Alcosuisse, purity of >99%. Urea was purchased from Merck KGaA with a purity >99%.

### Example 1

A suspension containing 0.9 wt % microfibrillated cellulose and 0.9 wt % urea in water has been provided. The suspension has been mechanically agitated and simultaneously cooled to a half-frozen suspension, meaning that approximately 50 wt % of the water was present in solid state. The half-frozen suspension was transferred into a casting mold of cubic shape with an edge length of 3.2 cm. The suspension was then completely frozen by means of a freezer with a temperature of −35° C. and for at least three hours, until the suspension was substantially frozen.

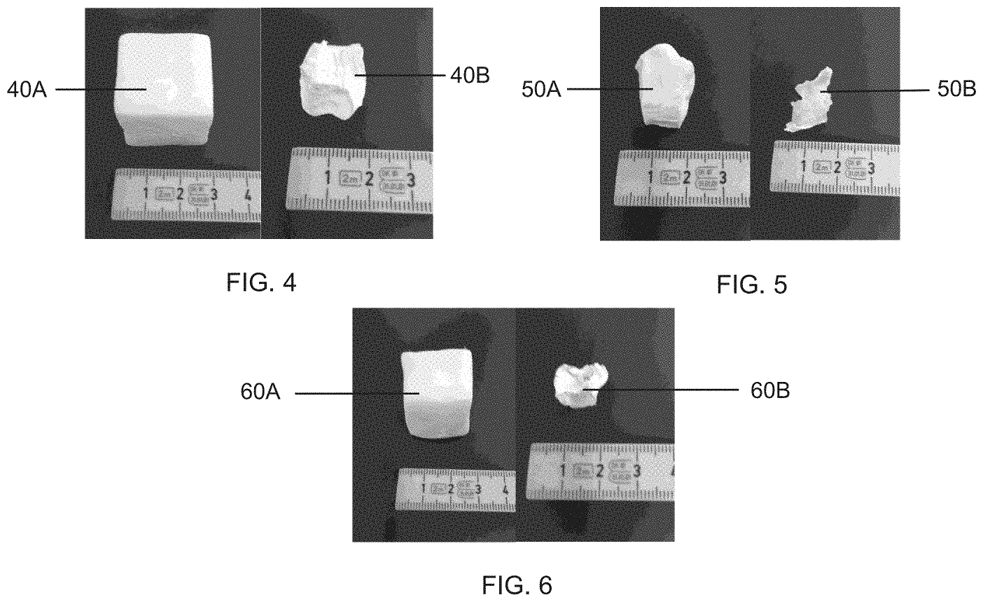

The obtained frozen cubes of microfibrillated cellulose-based foam have been subjected to a solvent exchange bath in ethanol until the foam was substantially solvent saturated. The ethanol has been removed by drying the foam in a convection oven at 65° C. resulting in a dry foam (FIG. 4, 40A).

### Example 2

The frozen cellulose-based cubes have been prepared as described with regard to example 1, but the cubes have been thawed in water. The water has been removed by drying in a convection oven at 65° C. resulting in dry foam (FIG. 4, 40B).

FIG. 4 provides a comparison between the foam 40A obtained according to example 1 and the foam 40B obtained according to example 2. Without thawing the foam in ethanol (example 2), a severe shrinkage of the material and structural loss can be observed (FIG. 4, 40B), whereas the solvent exchange, respectively the solvent thawing step, supports the maintenance of the structure of the foam upon drying (FIG. 4, 40A). The edge length of the cubic microcellulose based foam 40A varied between 2.9 cm and 2.7 cm, corresponding to a partial shrinkage in volume between 25 and 40%. The shrinkage of foam 40B could not be measured due to partial collapse of the foam, what indicates that solvent exchange is a prerequisite for maintaining the structure of the foam.

### Comparative Example 3

A suspension containing 0.9 wt % microfibrillated cellulose and 0.9 wt % urea in water has been provided. The suspension has been poured into casting molds of cubic shape with an edge length of 3.2 cm and subjected to rapid freezing with liquid nitrogen for 10 minutes. The resulting frozen microcellulose-based foams in the cubes have been thawed in ethanol (FIG. 5, 50A), followed by drying according to the conditions as mentioned with regard to example 1 and 2.

### Comparative Example 4

A suspension containing 0.9 wt % microfibrillated cellulose and 0.9 wt % urea in water has been provided. The suspension has been poured into casting molds of cubic shape with an edge length of 3.2 cm and subjected to rapid freezing with liquid nitrogen for 10 minutes.

The resulting frozen microcellulose-based foams in the cubes have been thawed in water (FIG. 5, 50B), followed by drying according to the conditions as mentioned with regard to example 1 and 2.

In FIG. 5, both foams 50A and 50B show a severe shrinkage upon drying. The foam thawed in water 50B showed a much higher shrinkage than the foam thawed in ethanol 50A. Further, the cube shapes collapsed upon drying and are completely lost compared to foam 40A (example 1).

### Comparative Example 5

A suspension containing 0.9 wt % microfibrillated cellulose and 0.9 wt % urea in water has been provided. The suspension has been poured into casting molds of cubic shape with an edge length of 3.2 cm and subjected unidirectional ice templating, meaning the casting molds with the suspension were placed in a freezer at −35° C. for 3 hours until the suspension was substantially frozen. The resulting frozen microcellulose-based foams in the cubes have been thawed in ethanol (FIG. 6, 60A), followed by drying according to the conditions as mentioned with regard to example 1 and 2.

### Comparative Example 6

A suspension containing 0.9 wt % microfibrillated cellulose and 0.9 wt % urea in water has been provided. The suspension has been poured into casting molds of cubic shape with an edge length of 3.2 cm and subjected unidirectional ice templating, meaning the casting molds with the suspension were placed in a freezer at −35° C. for 3 hours until the suspension was substantially frozen. The resulting frozen microcellulose-based foams in the cubes have been thawed in water (FIG. 6, 60B), followed by drying according to the conditions as mentioned with regard to example 1 and 2.

In FIG. 6. the foam 60A maintains its cubic shape after drying. However, the edge length of the cubic microcellulose based foam 60A varied between 2.7 cm and 2.6 cm corresponding to a shrinkage between and 40% and 44.5% and shrinkage is thus higher compared to example 1 with foam 40A. The foam 60B showed a severe shrinkage after drying. The cubic shape is lost.

Cut Foam Picture

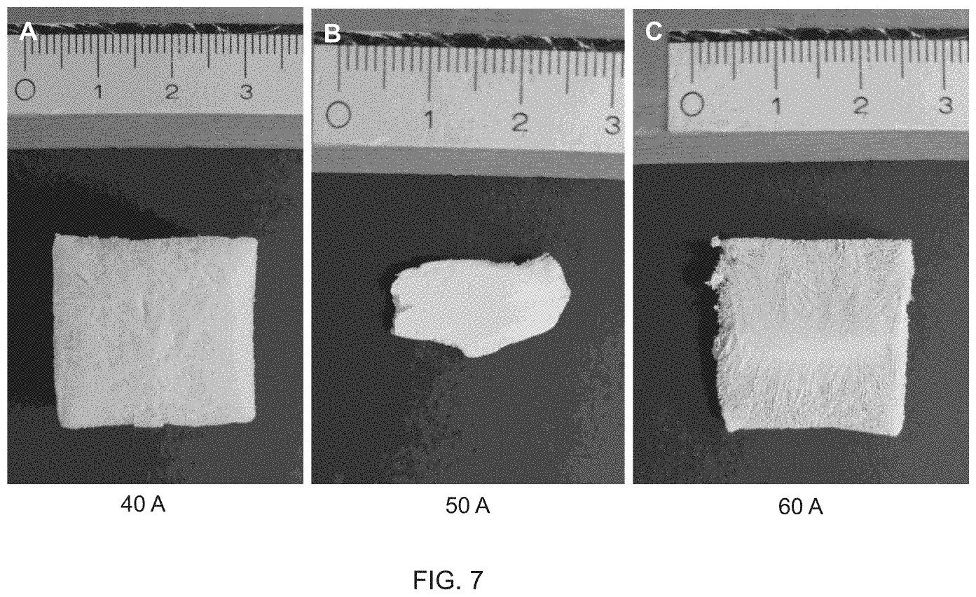

The foams 40A, 50A and 60A have been cut in the center and imaged with a conventional camera of 12 Megapixel. The images of the respective foams are shown in FIG. 7. The foam 40A obtained by a method according to the invention (example 1) shows a good homogeneity of the pores by visual inspection as can be seen in FIG. 7A. For foam 60A (comparative example 5) the freezing direction can be determined since crystals have been formed along the freezing direction as provided in FIG. 7C. Further, the visual inspection of foam 60A indicates channels rather than pores. Foam 50A (comparative example 3) as imaged in FIG. 7B and obtained by rapid freezing does not show pores by visual inspection and seems of rather compact structure.

Scanning Electron Microscope and Optical Microscope

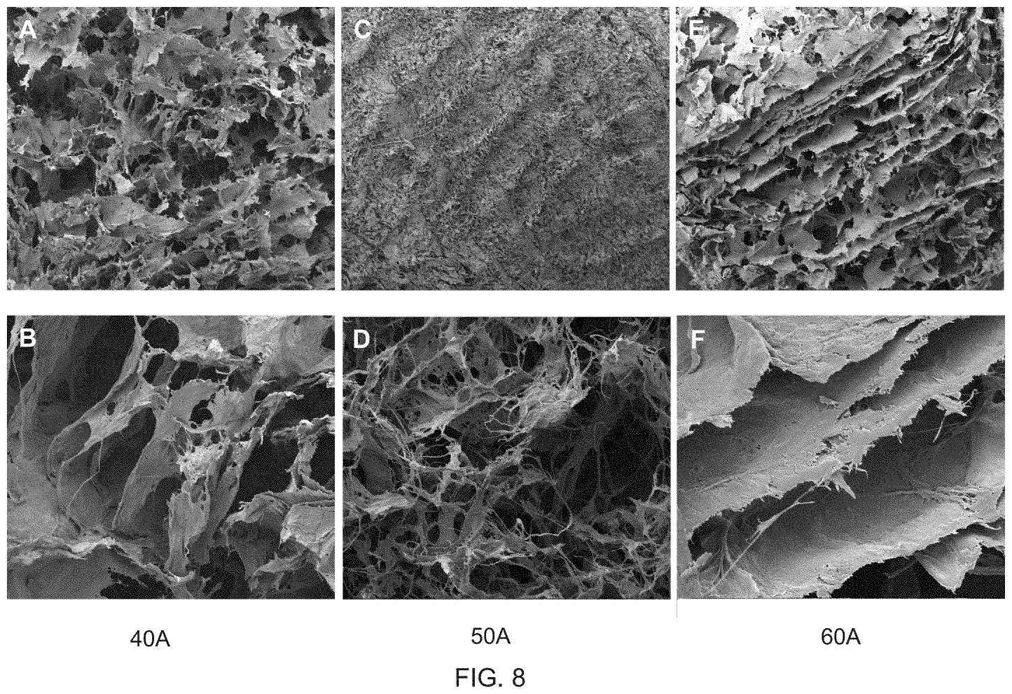

The microscopic images of foams 40A, 50A and 60A are provided in FIG. 8. The images have been recorded with a FEI NanoSEM 230. FIGS. 8A, 8C and 8E were recorded with a resolution of 1 mm. FIG. 8B was recorded with a resolution of 300 μm FIGS. 8D and 8F were recorded with a resolution of 50 nm.

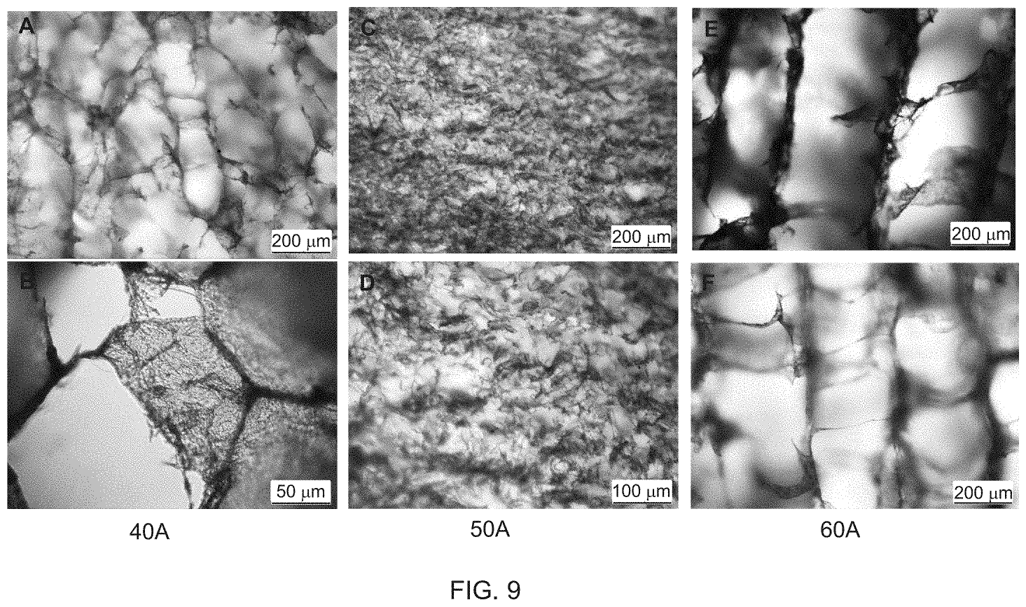

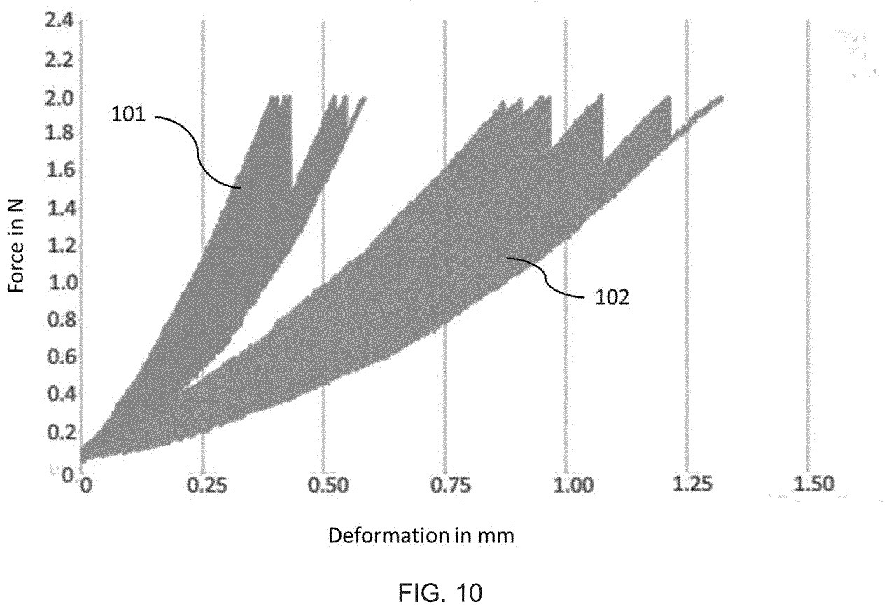

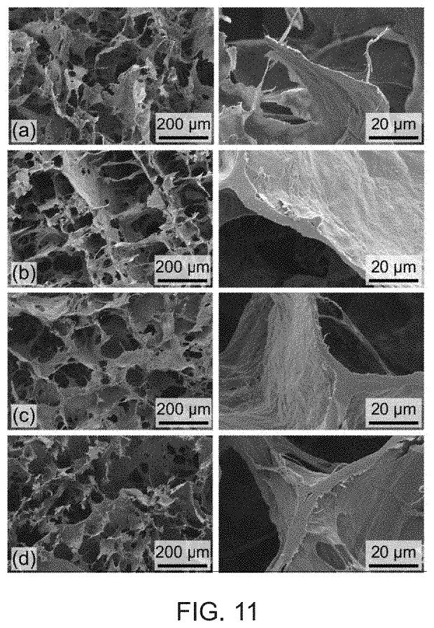

Optical microscope images of foam 40A, 50A and 60A were recorded with a Zeiss Axioplan and a magnification up to 40× and are shown in FIG. 9, FIGS. 9A, 9C, 9E and 9F show a resolution of 200 μm, FIG. 9B shows a resolution of 50 μm and FIG. 9F of 100 μm.

FIGS. 8A and 8B show the microscopic images of the foam 40A, obtained by a method according to the invention (example 1). In FIG. 8A the homogeneous pore distribution is clearly visible. FIG. 8B is a higher resolution of FIG. 8A showing that the pores are separated by walls of cellulose fibers. The pore structure was also confirmed by optical microscope imaging as shown in FIGS. 9A and 9B.

FIGS. 8C and 8D show the microscopic images of the foam 50A (comparative example 3), obtained by rapid freezing with nitrogen. FIG. 8C shows a resolution of 1 mm, suggesting a very compact structure of small pores. FIG. 8D is a higher resolution of FIG. 8C and shows a network of cellulose fibers without the presence of structured pores. The optical microscope images of foam 50A in FIGS. 9C and 9D also show a loose fiber network instead of pores.

FIGS. 8E and 8F display the microscopic images of the foam 60A obtained by unidirectional ice templating according to comparative example 5. While the visual inspection in FIGS. 4 and 6 suggested a similar structure of foam 40A and foam 60A, the microscopic images for the foam 60A show channels rather than pores. The formation of channels is also confirmed by optical microscope imaging of foam 60A, which images are shown in FIGS. 9E and 9F.

Bet Measurements

BET measurements were performed on a Tristar II plus and according to ISO 9277, 2^{nd} edition, 2010-09. The foam was divided in the center with a scalpel and the sample was comminuted such that it could be filled into the respective BET tube. Two measurements have been performed for each foam, except for foam 50B due to its severe shrinkage and unsuitability for such measurements. The results of the measurements are provided in table 1.

TABLE 1
BET measurements

| | BET | Average BET |
|---|---|---|
| foam | surface in m²/g | surface in m²/g |
| 40A - 1 | 59.70 | 57.22 |
| 40A - 2 | 54.74 | |
| 40B - 1 | 3.93 | 3.80 |
| 40B - 2 | 3.68 | |
| 50A - 1 | 9.83 | 9.93 |
| 50A - 2 | 10.03 | |
| 50B - 1 | 3.54 | 3.54 |
| 50B - 2 | — | |
| 60A - 1 | 57.93 | 57.53 |
| 60A - 2 | 57.14 | |
| 60B - 1 | 0.85 | 1.86 |
| 60B - 2 | 2.88 | |

The BET surface area is similar for the foams 40A and 60A, both subjected to a solvent exchange step, while all foams lacking the solvent exchange step show a severely reduced BET surface.

Oil Absorption Measurements

Foams 40A and 60A have been subjected to oil absorption measurements. Oil absorption measurements were conducted as follows: Approximately 100 ml of a mixture of straight-chain paraffins and 1-methylnaphthalene with a density of ρ=820 kg/m³ and a surface tension σ=23.0±0.3 mN/m were used as oil. The foam was stored in the oven at 60° C. for at least one hour to make sure it was fully dry, then taken out, foam mass was measured and recorded. Then, a beaker was filled with approx. 100 mL of oil, the foam was immersed, kept in the oil for at least 30 s, then taken out using tweezers and the total mass of foam (m_{foam}) and oil (mₒᵢₗ) was measured again. Oil absorption capacity was then calculated as C=mₒᵢₗ/ρₒᵢₗ=(mₜₒₜ−m_{foam})/ρₒᵢₗ.

TABLE 2a
absorption measurements according to initial
microfibrillated cellulose concentration

| | | foam mass | foam mass | ratio | ratio |
|---|---|---|---|---|---|
| | | [g] before | [g] after | [Lₒᵢₗ/kg_{cell}] | [Lₒᵢₗ/kg_{cell}] |
| foam | sample | absorption | absorption | mean | std. |
| 40A | 1 | 0.391 | 20.22 | 61.5 ± 0.33 | |
| 40A | 2 | 0.402 | 21.01 | | |
| 60A | 1 | 0.306 | 18.26 | 62.7 ± 8.05 | |
| 60A | 2 | 0.311 | 14.41 | | |

Comparing these examples with regard to their absorption properties (table 2a), the absorption seems to be slightly better with the foam obtained by unidirectional ice templating (60A, comparative example 5) than those obtained with a foam according to example 1 (40A).

However, using the same initial concentration of microfibrillated cellulose to obtain foams 40A and 60A leads to different foam masses before absorption. The foam mass of foam 40A is higher compared to the foam mass of foam 60A. Without being bound by theory, it is expected that the different masses are a result of the different preparation methods. In the preparation method according to the invention (example 1), the cellulose-containing suspension is concentrated during the cooling-agitation step and thus resulting in a higher concentration of cellulosic material compared to the method of unidirectional ice templating (comparative example 5). In order to compare the results on the basis of the same foam mass before oil absorption, another foam has been prepared with a method according to the invention as presented in example 7.

### Example 7

A foam 70A has been prepared according to example 1 with the exception that a suspension containing 0.6 wt % microfibrillated cellulose and 0.6 wt % urea in water has been provided. The foam 70A has a foam mass before absorption similar to those of foam 60A. When the absorption capacity is compared in relation to the foam mass after preparation of the foams and before absorption measurement, the absorption capacity of the foam 70A obtained according to a method of the invention significantly increases compared to a foam obtained by unidirectional ice templating 60A (table 2b).

TABLE 2b
absorption measurement according to foam mass before absorption

| | | foam mass | foam mass | ratio | ratio |
|---|---|---|---|---|---|
| | | [g] before | [g] after | [Lₒᵢₗ/kg_{cell}] | [Lₒᵢₗ/kg_{cell}] |
| foam | sample | absorption | absorption | mean | std. |
| 40A | 1 | 0.391 | 20.22 | 61.5 ± 0.33 | |
| 40A | 2 | 0.402 | 21.01 | | |
| 60A | 1 | 0.306 | 18.26 | 62.7 ± 8.05 | |
| 60A | 2 | 0.311 | 14.41 | | |
| 70A | 1 | 0.274 | 16.64 | 72.7 ± 0.6 | |
| 70A | 2 | 0.279 | 17.22 | | |

Mechanical Strength

Foams 40A and 60A obtained with the method described with respect to example 1 and comparative example 5, respectively, have been subjected to mechanical strength measurements.

Mechanical strength measurement were conducted as follows: The test specimens are loaded with a preload of 0.1 N. Then a force F_{Max} of 2 N is applied at a test speed of 2 mm/min. The deformation of the test specimens is recorded. After reaching F_{Max}, the test specimen is relieved and a relaxation time of one minute is maintained. A further measuring cycle is then carried out. A total of five measuring cycles are carried out per test specimen.

The open surface (i.e. the surface which is free during the freezing process) was oriented parallel to the test direction.

The measurements were performed on a tensile tester purchased from Zwick-Roell (Ulm, Germany, Type: BTI-FB005TN.D14)

FIG. 10 groups the deformation of the five measured cycles in relation to the preparation method of the foams. Graph 101 shows the formation with regard to foams 40A obtained by a method according to the invention. Graph 102 shows the deformation with regard to foams 60A obtained by unidirectional ice templating. The foams obtained by the method according to the invention are less deformed than the foams obtained by unidirectional ice templating.

The average deformation at a standard force of 2 Newton in relation to the preparation method of the foams is displayed in table 3. The test specimens produced by a method according to the invention (ICM) show an average deformation, which is 54.75% lower than that of the test specimens produced with the state of the art unidirectional ice templating (DF).

TABLE 3
Average deformation in relation to the preparation method.

| foam | Preparation method | Deformation in mm |
|---|---|---|
| 40A | ICM | 0.48 |
| 60A | DF | 1.07 |

Wall Thickness

FIG. 11 shows SEM images, recorded with Fei Nova Nanosem 230 Instrument (Fei, USA), of cellulose foams according to the invention and produced via a agitation-cooling process according to the invention with different concentration of microfibrillated cellulose: (a) 0.69 wt. %, (b) 1.16 wt. %, (c) 2.03 wt. %, (d) 2.39 wt. %. Images on the left column display the characteristic porosity with pore sizes in the order of 100 μm. Images on the right column display the wall thickness and theses are in the ranges of 1 to 10 μm and increases for increasing concentrations of microfibrillated cellulose.

1. A method for the preparation of a porous nano- and/or microscale cellulose-based foam comprising the steps of:
a) providing a suspension comprising nano- and/or microscale cellulose in an aqueous medium;
b) simultaneously cooling and agitating the suspension in a mechanical step to obtain an at least partially frozen suspension;
c) freezing the at least partially frozen suspension to obtain a substantially frozen suspension;
d) treating the suspension under solvent-exchange; and
e) removing the solvent to obtain a substantially dry foam comprising nano- and/or microscale cellulose.

2. The method according to claim 1, wherein the suspension comprises 0.3 to 3 wt. % of nano- and/or microscale cellulose.

3. The method according to claim 1, wherein the suspension additionally comprises urea.

4. The method according to claim 1, wherein the at least partially frozen suspension in step b) comprises 10-90 wt % of aqueous medium in solid state.

5. The method according to claim 1, wherein the at least partially frozen suspension obtained in step b) is poured into a mold.

6. The method according to claim 1, wherein the solvent is a water-miscible solvent with a boiling point below 100° C. at standard ambient conditions.

7. The method according to claim 1, wherein the solvent is recycled.

8. The method according to claim 1, wherein the method additionally comprises the step of hydrophobizing the foam comprising nano- and/or microscale cellulose.

9. The method according to claim 1, wherein the nano- and/or microscale cellulose is nano- and/or microfibrillated cellulose.

10. A nano- and/or microscale cellulose based foam obtainable by a method comprising the steps of:
a) providing a suspension comprising nano- and/or microscale cellulose in an aqueous medium;
b) simultaneously cooling and agitating the suspension in a mechanical step to obtain an at least partially frozen suspension;
c) freezing the at least partially frozen suspension to obtain a substantially frozen suspension;
d) treating the suspension under solvent-exchange; and
removing the solvent to obtain a substantially dry foam comprising nano- and/or microscale cellulose.

11. The nano- and/or microscale cellulose based foam according to claim 10, wherein the foam has a density of 0.01-0.3 g/cm³.

12. The nano- and/or microscale cellulose based foam according to claim 10, wherein the foam has a specific BET surface area between 30 m²/g and 100 m²/g.

13. The nano- and/or microscale cellulose based foam according to claim 10, wherein the foam has an oil absorption property of more than 40 Lₒᵢₗ/kg_{cell}.

14. The method according to claim 1, wherein the nano- and/or microscale cellulose based foam produced in accordance to steps a)-e) is used to sorb fluids, in particular for the absorption of oil.

15. The method according to claim 1, wherein the nano- and/or microscale cellulose based foam produced in accordance to steps a)-e) is used as an electrical insulating material.

16. The method according to claim 2, wherein the suspension comprises 0.9 to 2.5 wt. % of nano- and/or microscale cellulose.

17. The method according to claim 3, wherein the suspension comprises between 0.5 and 3 wt % urea.

18. The method according to claim 4, wherein the at least partially frozen suspension in step b) comprises 30-70 wt % of aqueous medium in solid state.

19. The method according to claim 6, wherein the solvent is ethanol.

20. The nano- and/or microscale cellulose based foam according to claim 13, wherein the foam has an oil absorption property of more than 70 Lₒᵢₗ/kg_{cell}.

21. The method according to claim 14, wherein the nano- and/or microscale cellulose based foam produced in accordance to steps a)-e) is used to absorb oil.
